(19) United States
(12) Patent Application Publication
(10) Pub. No.: US 2003/0174152 A1
(43) Pub. Date: Sep. 18, 2003

(54) Display apparatus with function which makes gradiation control easier

(76) Inventor: Yukihiro Noguchi, Motosu-gun (JP)

Correspondence Address: MCDERMOTT WILL & EMERY, 600 13TH STREET, N.W., WASHINGTON, DC, 20005-3096, US

(21) Appl. No.: 10/354,183

(22) Filed: Jan. 30, 2003

(30) Foreign Application Priority Data
Feb. 4, 2002 (JP) 2002-026609
Jan. 14, 2003 (JP) 2003-006056

(51) Int. Cl. G09G 5/10

(52) U.S. Cl. 345/690

(57) ABSTRACT

When a data transferring transistor turns on, luminance data being applied to a data line is set in a drive transistor in the form of a data voltage. A current corresponding to the data voltage thus set flows to the drive transistor and simultaneously the same current flows to a first current mirror transistor. Then, a current corresponding to the ratio of a driving capability of a second current mirror transistor to that of the first current mirror transistor flows to the second current mirror transistor.

### BACKGROUND OF THE INVENTION

1. Field of the Invention

The present invention relates to a display apparatus and more particularly to a technology for improving the display quality of active-matrix type display apparatuses.

2. Description of the Related Art

The use of notebook personal computers and portable terminals is spreading rapidly. Displays mainly used for such equipment are liquid crystal displays, but the display considered promising as a next-generation flat display panel is the organic EL (Electro Luminescence) display. The liquid crystal display apparatus still have such unsolved problems as narrow viewing angle and slow response speed. The organic EL display apparatus, on the other hand, have not only overcome such shortcomings of LCDs but also achieved high luminance and high efficiency.

It is the active matrix drive system that is central as a display method for such displays. The display using this system is called the active matrix display where a multiplicity of pixels are vertically and horizontally disposed in a matrix, and a switching element is provided for each pixel. Image data are written into each pixel sequentially by the switching element.

The research and development for designing practical organic EL displays is now in the pioneer days, when a variety of pixel circuits are being proposed. One example of such circuits is a pixel circuit disclosed in Japanese Patent Application Laid-Open No. Hei11-219146, which will be briefly explained hereinbelow with reference to FIG. 7.

This circuit is comprised of a data transferring transistor Tr11 and a drive transistor Tr12, which are two n-channel transistors, an organic light emitting diode (simply referred to as OLED hereinafter) which is an optical element, a storage capacitance SC11, a scanning line SL, a power supply line Vdd and a data line DL which inputs luminance data.

This circuit operates as follows. To write luminance data of the OLED 10, the scanning line SL turns high and the data transferring transistor Tr11 turns on, and the luminance data inputted to the data line DL is set in both the drive transistor Tr12 and the storage capacitance SC11. At the timing of luminescence, the scanning line SL becomes low, thereby turning the data transferring transistor Tr11 off and thus holding voltage at the gate of the drive transistor Tr12, so that the OLED 10 emits light according to the set luminance data.

On the other hand, there is much demand of the users for higher quality of display. In fact, the users tend to prefer display apparatus with a greater multiplicity of gradation levels. However, such requirement for a larger number of gradation levels means a necessity for a control just as much fine-tuned. In other words, division of the signal range of luminance data into such a number of gradation levels creates smaller difference of signals between gradation levels, thus making the gradation control more difficult.

### SUMMARY OF THE INVENTION

The present invention has been made in view of the foregoing circumstances and an object thereof is to provide a novel circuit which makes gradation control easier.

A preferred embodiment according to the present invention relates to a display apparatus. This apparatus includes: an optical element; a drive circuit which drives the optical element; and a conversion circuit which converts a driving capability of the drive circuit, wherein the driving capability which has been converted by the conversion circuit operates on the optical element. Here, what is assumed as the optical element may be an organic light emitting diode or a liquid crystal display device, but is not limited thereto.

A data signal corresponding to luminance data of the optical element needs to be set according to the desired number of gradation levels. If the number of gradation level is large, the difference of the data signals between gradation levels is small, so that control therefore becomes difficult. Thus, a relatively large signal is used in setting the data signal, and said signal is converted by the conversion circuit, so that luminance of the optical element is set to a desired value. For example, in a case when the gradation of the luminance is 10 and the range of the data signal to be set is 1 V, the control in the units of 0.1 V is required per gradation. On the other hand, in a case when the range of the data signal to be set is 10 V, the control in the units of 1 V suffices per gradation and its controlling becomes easy.

Moreover, the conversion circuit includes a current mirror circuit, and after a current flowing through the drive circuit is multiplied by a predetermined factor by the current mirror circuit, said current may be fed to the optical element. In particular, since the organic light emitting diode is a current-driven type optical element, the control by such a current mirror circuit is effective in an organic EL display apparatus.

For example, in a case where the current mirror circuit is comprised of transistors, the amount of current flowing through the circuit is converted in accordance with a ratio of driving capabilities of these transistors. Thus, if the ratio of driving capabilities of the transistors is 10:1, the ratio of the current flowing through these transistors will also be 10:1. The driving capability is, general, inversely proportional to the gate length of the transistor and proportional to the gate width thereof.

Moreover, the conversion circuit further includes a shutoff means which substantially shuts off a current flowing to the current mirror circuit, and the luminance of the optical element may be controlled by controlling the shutoff means. For example, if the current mirror circuit is comprised of two thin film transistors (hereinafter referred to as TFT), the shutoff means operates on a node to which those two gate electrodes are connected. Thus, these TFTs are turned off and the current flowing to the current mirror circuit is substantially shut off. Here, it suffices that the shutoff means functions as a switching element, and a transistor, for example, serves the purpose.

Moreover, the conversion circuit includes a current branch circuit, and part of currents flowing to the drive circuit may be fed to the optical element. Then, resistive elements may be provided in parallel so that the current is branched out in accordance with a ratio of their resistance values. Moreover, transistors whose ON-state resistance values differ from each other may be provided in parallel, and the current may be branched out by turning on and off these transistors.

Another preferred embodiment according to the present invention relates also to a display apparatus. This apparatus sets luminance data in a driver element by an analog gradation method, and there is provided a conversion circuit to widen a setting range of the luminance data, in the display apparatus that drives an optical element.

It is to be noted that any arbitrary combination or recombination of the above-described structural components and expressions changed between a method, an apparatus, a system and so forth are all effective as and encompassed by the present embodiments.

Moreover, this summary of the invention does not necessarily describe all necessary features, so that the invention may also be sub-combination of these described features.

### BRIEF DESCRIPTION OF THE DRAWINGS

FIG. 1 shows a circuit of a pixel which includes a current mirror circuit, according to a first embodiment of the present invention.

FIG. 2 shows a pixel circuit according to a second embodiment of the present invention.

FIG. 3 shows a pixel circuit according to a third embodiment of the present invention.

FIG. 4 shows a pixel circuit according to a fourth embodiment of the present invention.

FIG. 5 shows a pixel circuit according to a fifth embodiment of the present invention.

FIG. 6 shows a pixel circuit according to a sixth embodiment of the present invention.

FIG. 7 shows a pixel circuit according to the conventional practice.

FIG. 8 shows a modified pixel circuit over the pixel circuit shown in FIG. 5.

FIG. 9 shows another modified pixel circuit over the pixel circuit shown in FIG. 5.

FIG. 10 shows a modified pixel circuit over the pixel circuit shown in FIG. 6.

FIG. 11 shows another modified pixel circuit over the pixel circuit shown in FIG. 6.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In preferred embodiments according to the present invention, an active-matrix type organic EL display apparatus is assumed as a display apparatus, and the current that is directly converted and flows from a driver element in which luminance data are set is converted so as to reduce the current that flows to the OLED, which is an optical element. This makes gradation control easier by widening the range of signals when setting the luminance data.

First Embodiment

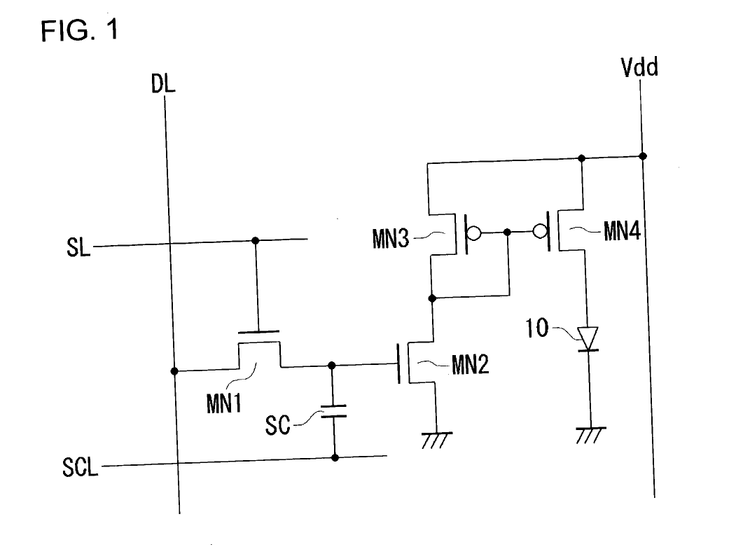

According to a first embodiment of the present invention, a current mirror circuit is provided to control the current that flows to an OLED. FIG. 1 shows a circuit of a pixel which includes a current mirror circuit. A pixel includes a data transferring transistor MN1, a drive transistor MN2, a first current mirror transistor MN3, a second current mirror transistor MN4, an OLED 10 and a storage capacitance SC. Moreover, a scanning line SL is shared by a same pixel row and, similarly, a data line DL and a power supply line Vdd are shared by a same pixel column. While the data transferring transistor MN1 and the drive transistor MN2 are n-channel TFTs, the first current mirror transistor MN3 and the second current mirror transistor MN4 are p-channel TFTs. The data transferring transistor MN1, which functions as a switching element, may be comprised of a plurality of TFTs, and the combination thereof to realize a desired drive capacity is arbitrary.

A gate electrode of the data transferring transistor MN1 is connected to the scanning line SL, one of the remaining electrodes of the MN1 is connected to the data line DL, and the other of the remaining electrodes of the MN1 is connected to a gate electrode of the drive transistor MN2. A gate electrode and a drain electrode of the first current mirror transistor MN3 and a gate electrode of the second current mirror transistor MN4 are connected to a drain electrode of the drive transistor MN2. A source electrode of the first current mirror transistor MN3 and a source electrode of the second current mirror transistor MN4 are connected to the power supply line Vdd. Thus, the first current mirror transistor MN3 and the second current mirror transistor MN4 constitute the current mirror circuit.

A source electrode of the drive transistor MN2 is connected to ground potential. The gate electrode of the drive transistor MN2 is connected to a fixed potential line SCL, which has a fixed potential, via the storage capacitance SC. A drain electrode of the second current mirror transistor MN4 is connected to an anode of the OLED 10, and a cathode of the OLED 10 is connected to ground potential. It is to be noted that the storage capacitance SC, which is connected to the fixed potential line SCL here, may be connected to ground potential to which the source electrode of the drive transistor MN2 is connected. Moreover, the source electrode of the drive transistor MN2 and the cathode of the OLED 10, which are both connected to ground potential here, may be connected to negative potential.

An operation of the circuit structured as described above is explained hereinbelow. As the scanning line SL goes high, the data transferring transistor MN1 is turned on. Thereby, luminance data which is being applied to the data line DL is set in the drive transistor MN2 in the form of a data voltage. A current which corresponds to the data voltage thus set flows to the drive transistor MN2 and simultaneously the same current flows to the first current mirror transistor MN3.

By the function of the current mirror circuit, a current which corresponds to the ratio of the driving capability of the second current mirror transistor MN4 to that of the first current mirror transistor MN3 flows to the second current mirror transistor MN4. Suppose, for example, that the ratio of the driving capability of the first current mirror transistor MN3 to that of the second current mirror transistor MN4 is 10:1. Then a current, which is 1/10 of the current flowing to the drive transistor MN2, will flow to the second current mirror transistor MN4, that is, to the OLED 10.

It is to be noted that the data transferring transistor MN1, which is an n-channel TFT here, may be a p-channel TFT. Moreover, the OLED 10 may be provided in a position above the second current mirror transistor MN4. In other words, a path of the second current mirror transistor MN4 and the OLED 10 in this order from the power supply line Vdd to ground potential according to the first embodiment may be replaced by a path of the OLED 10 and the second current mirror transistor MN4 in this order from the power supply line Vdd to ground potential.

Second Embodiment

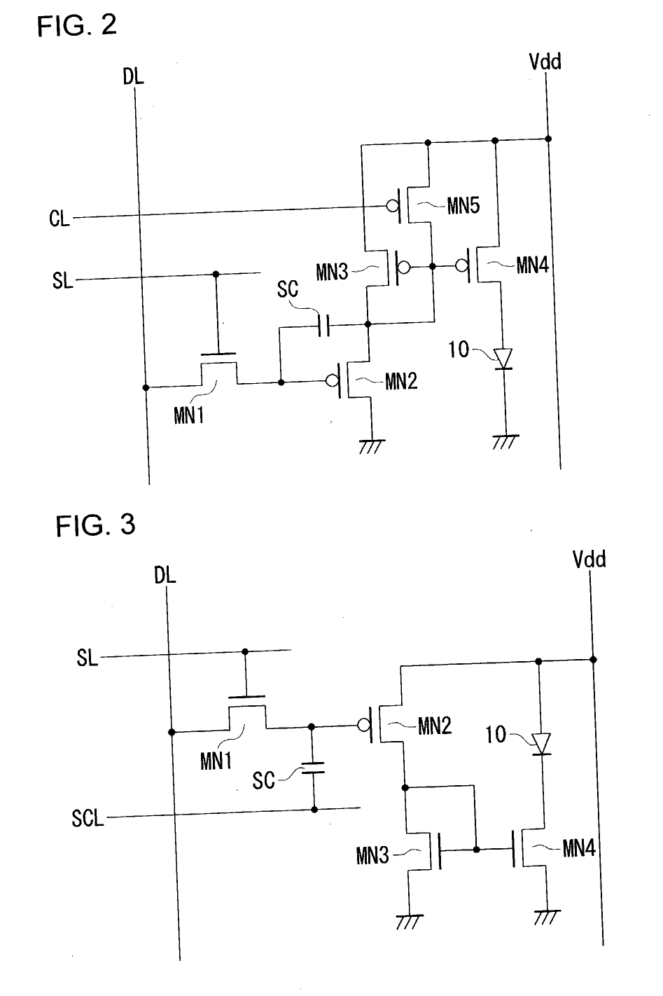

A second embodiment according to the present invention differs from the first embodiment in that, as shown in FIG. 2, a drive transistor MN2 is changed to a p-channel TFT and in that there is added thereto a potential defining transistor MN5 which defines potential at a source electrode of the drive transistor MN2 to be the potential at a power supply line Vdd when writing data voltage to a gate electrode of the drive transistor MN2. The potential defining transistor MN5 is a p-channel TFT. Moreover, the storage capacitance SC is provided between the gate electrode and the source electrode of the drive transistor MN2.

A drain electrode of the potential defining transistor MN5 is connected to a gate electrode and a drain electrode of the first current mirror transistor MN3 and a gate electrode of a second current mirror transistor MN4, and a source electrode of the MN5 is connected to a power supply line Vdd. A gate electrode of the potential defining transistor MN5 is connected to a control line CL, and the on and off of the MN5 are controlled by signals complementary to a scanning line SL. The structure of the circuit other than the above is the same as the circuit shown in FIG. 1.

An operation of the circuit structured as described above is explained hereinbelow. As the scanning line SL goes high, a data transferring transistor MN1 is turned on. At the same time, the control line CL goes low and the potential defining transistor MN5 turns on. Thereby, the potential at the source electrode of the drive transistor MN2 becomes equal to the potential at the power supply line Vdd, and luminance data which is being applied to the data line DL is set in the drive transistor MN2 in the form of a data voltage. At this time, the gate electrode of the first current mirror transistor MN3 and the gate electrode of the second current mirror transistor MN4 also attain the same potential as that of the power supply line Vdd. Thus, both the first current mirror transistor MN3 and the second current mirror transistor MN4 turn off, so that current will not flow to an OLED 10. That is, the OLED 10 will stop emitting light.

Next, as the scanning line SL goes low, the data transferring transistor MN1 is turned off. At the same time, the control line CL goes high and the potential defining transistor MN5 turns off. Thereby, a current, which corresponds to the data voltage set, flows to the drive transistor MN2 and simultaneously the same current flows also to the first current mirror transistor MN3. At this point, by the function of a current mirror circuit, a current which corresponds to the ratio of the driving capability of the second current mirror transistor MN4 to that of the first current mirror transistor MN3 flows to the second current mirror transistor MN4.

Here, the signal to be applied to the control line CL, which is a signal complementary to the signal to be applied to the scanning line SL, may be any signal such that the potential defining transistor MN5 is on while the data transferring transistor MN1 is on. Moreover, the luminance of the OLED 10 can be controlled by controlling the control line CL during the emission time of the OLED 10. The OLED 10 normally shows rapid deterioration with time. With color display apparatus, in particular, deterioration of the OLED 10 progresses unevenly for different colors, and continuous use may cause the loss of white balance of the display apparatus. However, the variation in luminance may be corrected and the white balance may be adjusted by controlling the control line CL with respect to each color.

Third Embodiment

A third embodiment according to the present invention differs from the first embodiment in that, as shown in FIGS. 3, a drive transistor MN2 is a p-channel TFT, a first current mirror transistor MN3 and a second current mirror transistor MN4 are n-channel TFTs, and an OLED 10 is provided in a position above the second current mirror transistor MN4. An operation of the circuit according to the third embodiment is the same as that of the circuit shown in FIG. 1 of the first embodiment, and the description thereof is omitted here.

Fourth Embodiment

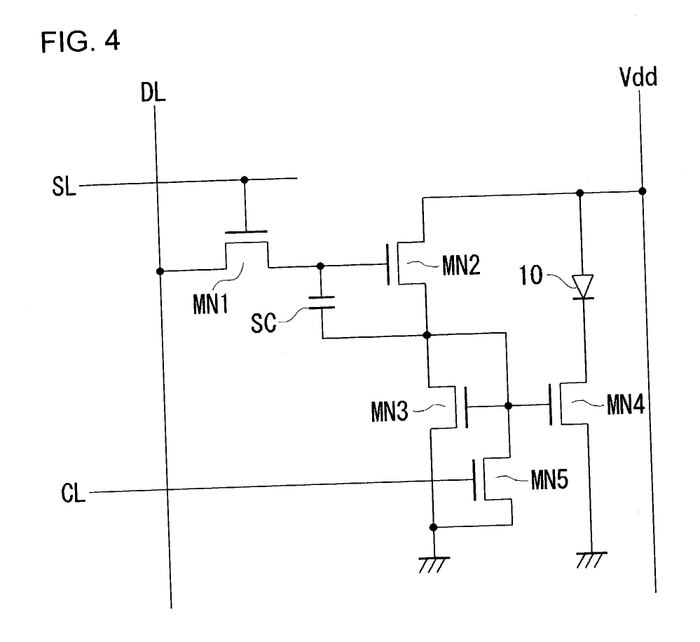

A fourth embodiment according to the present invention differs from the second embodiment in that, as shown in FIG. 4, a drive transistor MN2 is an n-channel TFT, a first current mirror transistor MN3 and a second current mirror transistor MN4 are n-channel TFTs, a potential defining transistor MN5 is an n-channel TFT, and an OLED 10 is provided in a position above the second current mirror transistor MN4. An operation of the circuit structured according to the fourth embodiment is the same as that of the circuit shown in FIG. 2 of the second embodiment, and the description thereof is omitted here.

Fifth Embodiment

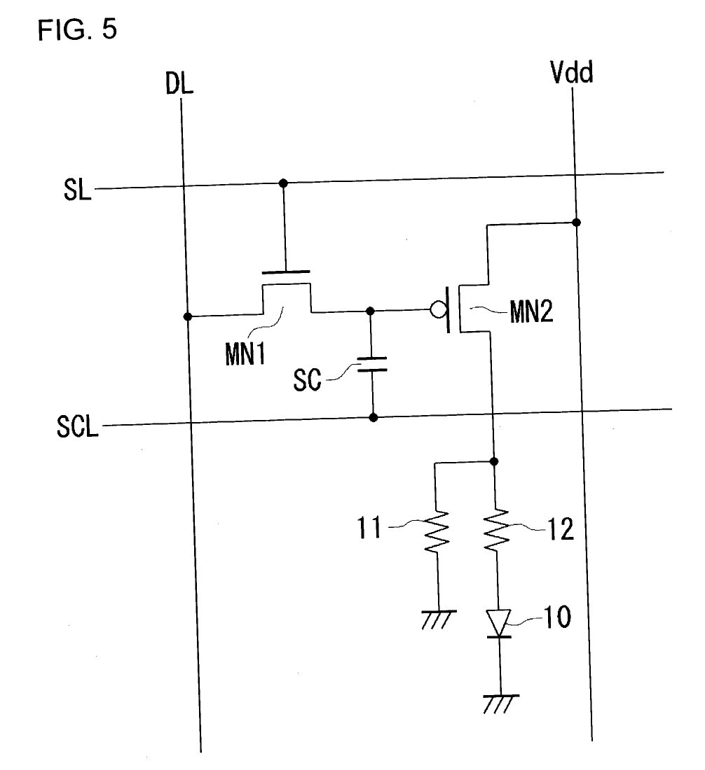

According to a fifth embodiment, the current flowing to an OLED is controlled by resistive elements provided in parallel with each other. FIG. 5 shows a circuit with those resistive elements provided thereto. A pixel includes a data transferring transistor MN1, a drive transistor MN2, a first resistive element 11, a second resistive element 12, an OLED 10 and a storage capacitance SC. Whereas the data transferring transistor MN1 is an n-channel TFT, the drive transistor MN2 is a p-channel TFT.

A gate electrode of the data transferring transistor MN1 is connected to a scanning line SL, one of the remaining electrodes of the MN1 is connected to a data line DL, and the other of the remaining electrodes of the MN1 is connected to a gate electrode of the drive transistor MN2. A drain electrode of the drive transistor MN2 is connected to one of the electrodes of the first resistive element 11 and one of the electrodes of the second resistive element 12, respectively, and a source electrode of MN2 is connected to a power supply line Vdd. The other of the electrodes of the first resistive element 11 is connected to ground potential. An anode of the OLED 10 is connected to the other of the electrodes of the second resistive element 12, and a cathode of the OLED 10 is connected to ground potential. Accordingly, the first resistive element 11 and the second resistive element 12 are connected in parallel with each other.

Now, the current flowing to the drive transistor MN2 is divided into a ratio of the sum of the resistance values of the second resistive element 12 and the OLED 10 to the resistance value of the first resistive element 11. Namely, if the current flowing to the drive transistor MN2 is denoted by IMN2, the resistance value of the first resistive element 11 by R1, the resistance value of the second resistive element 12 by R2, and the resistance value possessed by the OLED 10 by ROLED, then the current that flows to the OLED 10, or IOLED, is expressed as:

I_{OLED}=I_{MN2}×R1/(R1+R2+R_{OLED})

Hence, I_{OLED} can be made smaller than I_{MN2} by so arranging that the resistance value R1 of the first resistive element 11 is smaller than R2+R_{OLED}, which is the sum of the resistance value R2 of the second resistive element 12 and the resistance value R_{OLED} possessed by the OLED 10.

Sixth Embodiment

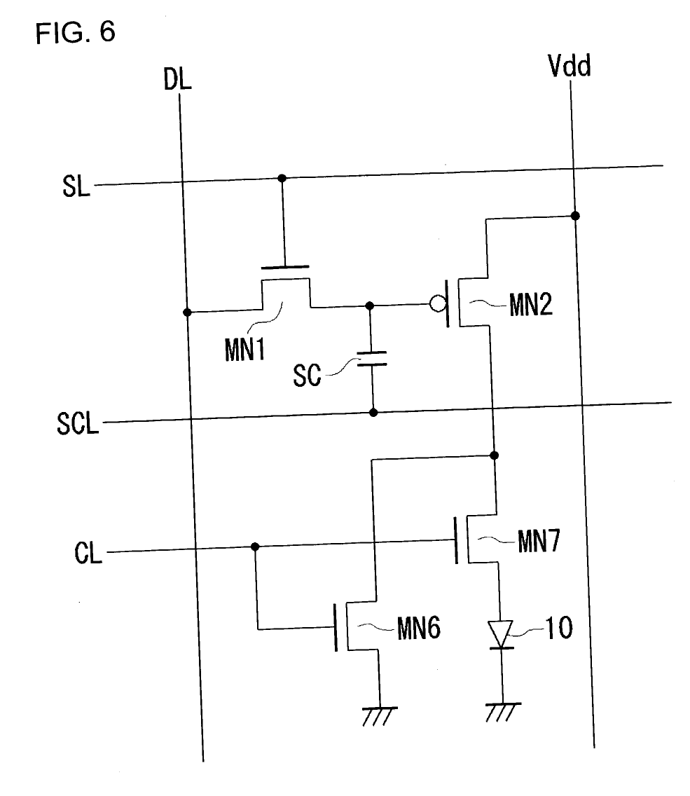

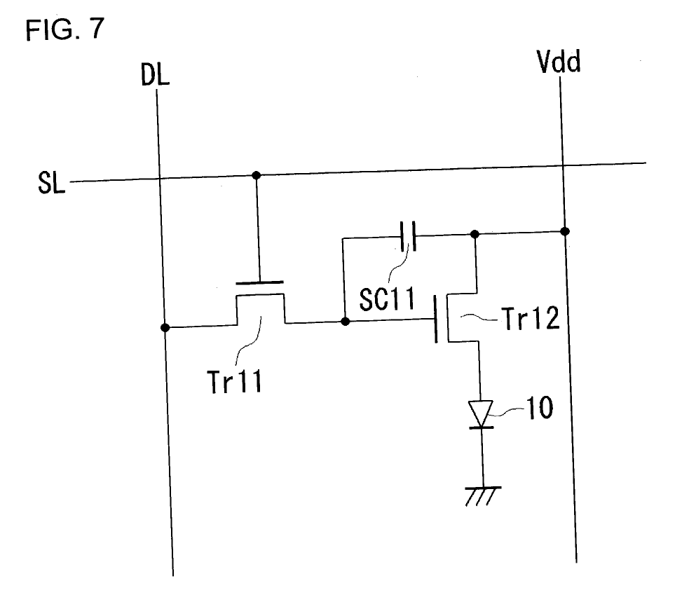

According to a sixth embodiment, as shown in FIG. 6, the first resistive element 11 and the second resistive element 12, which are the two resistive elements provided in the fifth embodiment, are replaced by a first current branch transistor MN6 and a second current branch transistor MN7, respectively, which are both n-channel TFTs. A control line CL which is connected to gate electrodes of these two TFTs and which controls these two TFTs is shared by these two TFTs.

Here, if ON-state resistance values of the first current branch transistor MN6 and the second current branch transistor MN7 are denoted as R1 and R2, respectively, then the current I_{OLED} that flows through the OLED 10 will be the same as that expressed in the fifth embodiment.

According to the first to sixth embodiments as described above, the current that actually flows to the OLED 10 can be made smaller than the current that is produced through direct conversion by the drive transistor MN2 in which luminance data is set. Accordingly, the range of luminance data to be set can be made wider and the luminance data per gradation level can be made larger, thereby making finer gradation control of luminance easier. Moreover, according to the second and fourth embodiments, the current flowing to the current mirror circuit is controlled by the potential defining transistor MN5 during the emission time of the OLED 10, so that the luminance of the OLED 10 can be controlled. Moreover, this luminance control contributes to compensating for the luminance degradation.

The present invention has been described based on embodiments which are only exemplary. It is understood by those skilled in the art that there exist other various modifications to the combination of each component and process therefore and that such modifications are encompassed by the scope of the present invention. Such modified examples will be described hereinbelow.

In the sixth embodiment, the control line CL is shared by the first current branch transistor MN6 and the second current branch transistor MN7, but the arrangement and configuration are not limited thereto. For example, separate control lines may be provided, and the first current branch transistor MN6 and the second current branch transistor MN7 may be controlled individually thereby to adjust the luminance.

Since the OLED which is an optical element of organic EL display apparatus normally shows conspicuous deterioration with time as already mentioned, it will provide an advantage to control the current branch transistors individually. For instance, when a desired luminance is no longer obtained due to the deterioration of the OLED, more current may be supplied by the second current branch transistor MN7. This can compensate for luminance degradation. Similarly, the luminance degradation can be compensated by the use of variable resistive elements for the resistive elements of the second embodiment.

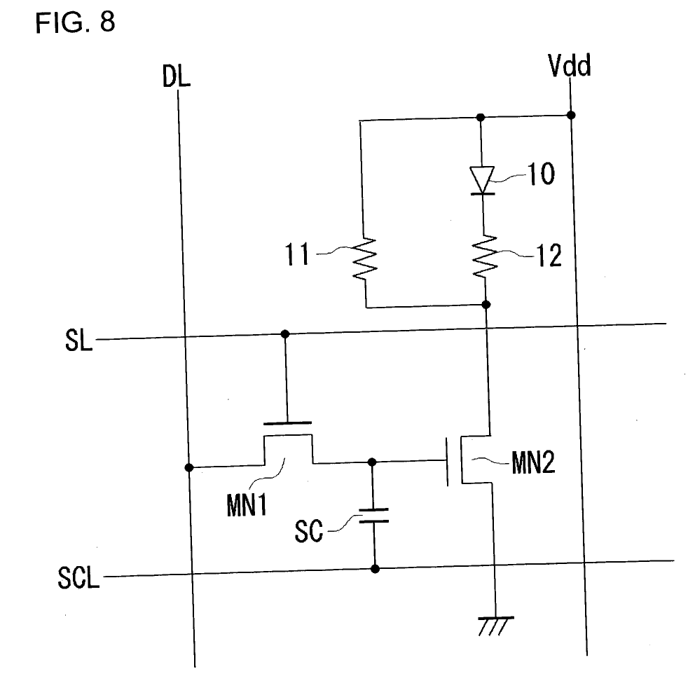

FIG. 8 is a modified example where the OLED 10 provided between the drive transistor MN2 and ground potential, the first resistive element 11 and the second resistive element 12 shown in FIG. 5 are now provided between the power supply line Vdd and the drive transistor MN2. Moreover, the drive transistor MN2 is changed to an n-channel TFT. The configuration and connection among these elements are as follows. Namely, the anode of the OLED 10 and one of electrodes of the first resistive element 11 are connected to the power supply line Vdd. The cathode of the OLED 10 is connected to one of electrodes of the second resistive element 12. The other of the electrodes of the first resistive element 11 and the other of the electrodes of the second resistive element 12 are connected to the drain electrode of the drive transistor MN2. The source electrode of the drive transistor MN2 is connected to ground potential. The rest of the structure for this modified example is the same as the structure of the pixel circuit shown in FIG. 5. An operation of this modified circuit shown in FIG. 8 is the same as that of the pixel circuit shown in FIG. 5, and the description thereof is omitted here.

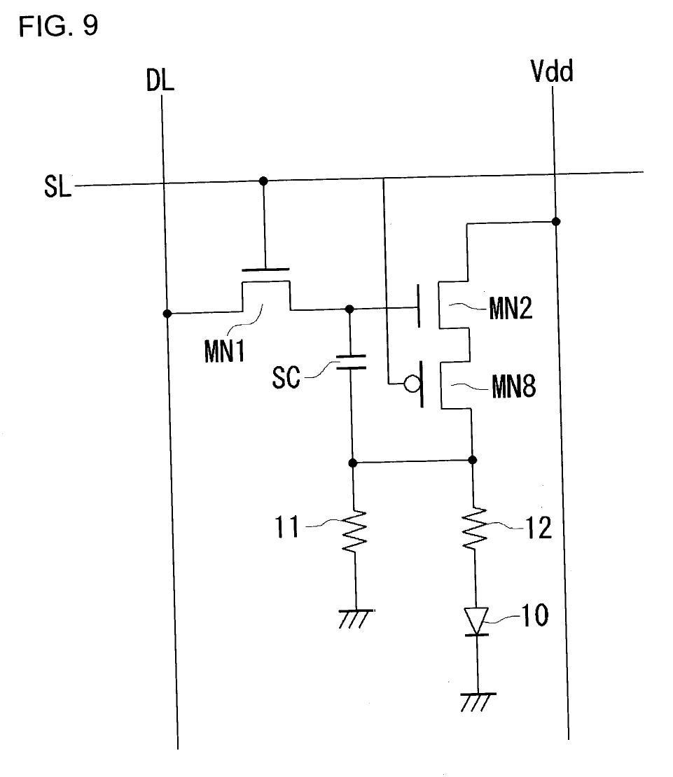

FIG. 9 is another modified example where, in the pixel circuit shown in FIG. 5 of the fifth embodiment, the drive transistor MN2 is changed to an n-channel TFT, and a current shutoff transistor MN8 which is a p-channel TFT is disposed in series between the drive transistor MN2 and the second resistive element 12. The current shutoff transistor MN8 functions as a switching element and a gate electrode of the MN8 is connected to scanning line SL. Moreover, as a result of the fact that the drive transistor MN2 is now changed to the n-channel TFT, the storage capacitance SC which stores the luminance data set in the gate electrode of the drive transistor MN2 is provided between an electrode opposite to the ground potential side of the first resistive element 11 and the gate electrode of the drive transistor MN2. Thus, the fixed potential line SCL provided in the pixel circuit in FIG. 5 is no longer necessary here.

An operation of this pixel circuit shown in FIG. 9 is described hereinbelow. As the scanning line is selected and the data transferring transistor MN1 is turned on, a data voltage being applied to the data line DL, that is, the luminance data, is set in the gate electrode of the drive transistor MN2 and the storage capacitance SC. At this time, the current shutoff transistor MN8 is in the off state. Thus, a path between the power supply line Vdd and the OLED 10 is electrically shut off, so that a node to which the storage capacitance SC and the first resistive element 11 are connected becomes ground potential. Moreover, the potential at the anode of the OLED 10 becomes ground potential, and the luminance data of the OLED 10 is initialized.

Thereafter, at the timing of luminescence the data transferring transistor MN1 turns off and the current shutoff transistor MN8 turns on. Then, the potential at the anode side of the OLED 10 changes from ground potential, but the electric charge of the storage capacitance SC is retained. Thus, a gate-source voltage set in the drive transistor MN2, that is, the luminance data, is maintained, and a desired current flows through the drive transistor MN2.

Here, the current shutoff transistor MN8 is connected to the scanning line SL and is on-off controlled by its selection signal. However, the current shutoff transistor MN 8 may be controlled by a different control signal. In such a case, the polarity of the current shutoff transistor MN8 may be either n-channel or p-channel type. However, in this case, a time period during which the current shutoff transistor MN8 is being on needs to contain and cover a time period during which the data transferring transistor MN1 is being on, namely, during which the luminance data is set. It is to be noted that a position at which the current shutoff transistor MN8 is to be disposed is arbitrary as long as the MN8 is disposed between the power supply line Vdd and the OLED 10. For instance, the current shutoff transistor MN8 may be provided between the second resistive element 12 and the OLED 10, or between the power supply line Vdd and the drive transistor MN2.

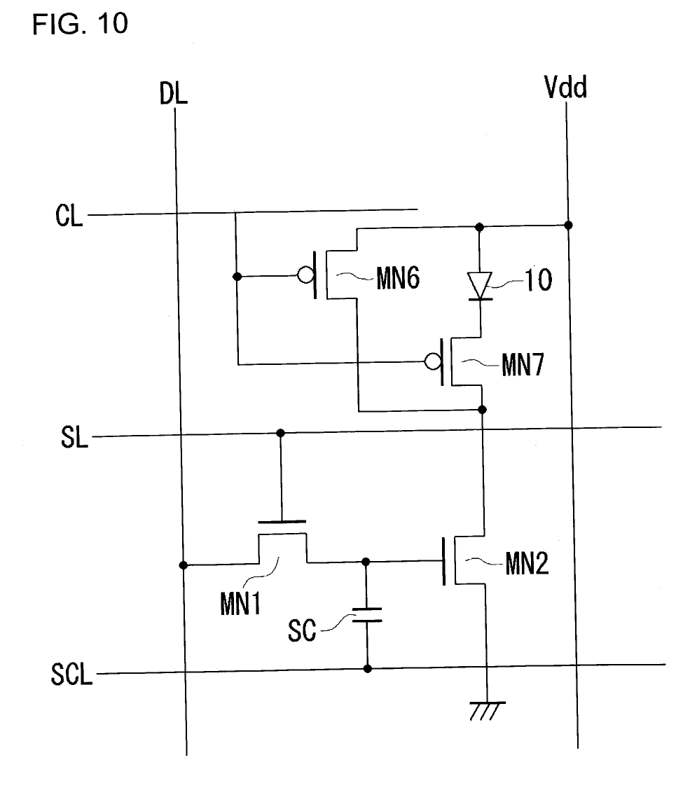

FIG. 10 shows a modified pixel circuit over the pixel circuit shown in FIG. 6. Namely, the first and second current branch transistors MN6 and MN7 provided between the drive transistor MN2 and ground potential and the OLED 10 are now provided between the power supply line Vdd and the drive transistor MN2, as shown in FIG. 10. Moreover, the first and second current branch transistors MN6 and MN7 are now changed to p-channel TFTS, and the gate electrodes of the first and second current branch transistors MN6 and MN7 are connected to the control line CL. The anode of the OLED 10 and one of the remaining electrodes of the first current branch transistor MN6 are connected o the power supply line Vdd whereas the cathode of the OLED 10 is connected to one of the remaining electrodes of the second current branch transistor MN7. The other of the remaining electrodes of the first current branch transistor MN6 and the other of the remaining electrodes of the second current branch transistor MN7 are respectively connected to the drain electrode of the drive transistor MN2. Thus, the OLED 10, the second current branch transistor MN7 and the drive transistor MN2, in this order of connection, constitute a series path from the power supply line Vdd to ground potential whereas the first current branch transistor MN6 forms a parallel path with respect to the OLED 10 and the second current branch transistor MN7. An operation of this pixel circuit shown in FIG. 10 may be the same as that of the pixel circuit shown in FIG. 6.

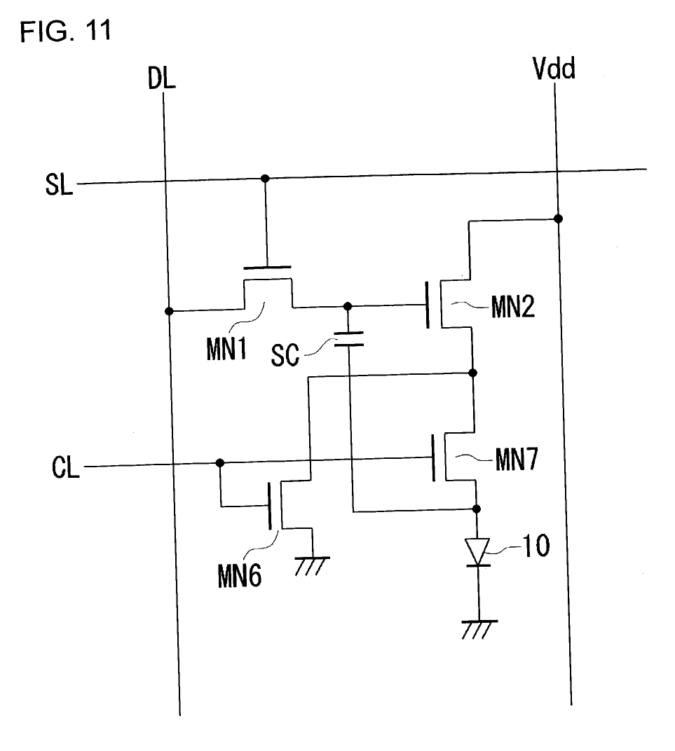

FIG. 11 is another modified pixel circuit where, in the pixel circuit shown in FIG. 6 of the sixth embodiment, the drive transistor MN2 is changed from the p-channel TFT to an n-channel TFT, and the storage capacitance SC is provided between the gate electrode of the drive transistor MN2 and the anode of the OLED 10. Thus, the fixed potential line SCL is not required here.

An operation of this pixel circuit shown in FIG. 11 is described hereinbelow. As the scanning line is selected and the data transferring transistor MN1 is turned on, a data voltage being applied to the data line DL, that is, the luminance data, is set in the gate electrode of the drive transistor MN2 and the storage capacitance SC. At this time, the control line is in the off state, and the potential at the anode of the OLED 10 drops to a potential which is determined by a time constant of the OLED 10 and a potential immediately prior thereto. Thereafter, at the timing of luminescence the data transferring transistor MN1 turns off and the control line CL goes high. Then, the potential at the anode side of the OLED 10 changes from ground potential, but the electric charge of the storage capacitance SC is retained. Thus, a gate-source voltage set in the drive transistor MN2, that is, the luminance data, is maintained, and a desired current flows through the drive transistor MN2. The current that flows through the OLED 10 will be the same as that in the sixth embodiment.

It is to be noted that the first current branch transistor MN6 and the second current branch transistor MN7 may be n-channel TFTs. In such a case, the gate electrodes of those two TFTs may be connected to the scanning line SL and may be on-off controlled by a selection signal of the scanning line SL.

Moreover, although in the pixel circuits shown in FIG. 5 and FIG. 6 one of the electrodes of the storage capacitance SC is connected to the fixed potential line SCL which is provided exclusively for its use, its configuration and connection thereof is not limited thereto and it may be connected to the power supply line Vdd. Moreover, in the pixel circuits shown in FIG. 8 and FIG. 10, one of the electrodes of the storage capacitance SC connected to the fixed potential line SCL may be connected to the ground potential which is the potential at the source electrode of the drive transistor MN2. In any of such a case, the fixed potential line SCL will not be required.

Although the present invention has been described by way of exemplary embodiments, it should be understood that many changes and substitutions may further be made by those skilled in the art without departing from the scope of the present invention which is defined by the appended claims.

What is claimed is:

1. A display apparatus, including:
an optical element;
a drive circuit which drives said optical element; and
a conversion circuit which converts a driving capability of said drive circuit,
wherein the driving capability which has been converted by said conversion circuit operates on said optical element.

2. A display apparatus according to claim 1, wherein said conversion circuit includes a current mirror circuit, and wherein after a current flowing through said drive circuit is multiplied by a predetermined factor by the current mirror circuit, the current flows to said optical element.

3. A display apparatus according to claim 2, wherein said conversion circuit further includes a shutoff means which substantially shuts off a current flowing to the current mirror circuit, and luminance of said optical element is controlled by controlling the shutoff means.

4. A display apparatus according to claim 1, wherein said conversion circuit includes a current branch circuit which directs part of currents flowing to said drive circuit to said optical element.

5. A display apparatus which sets luminance data in a driver element by an analog gradation method and which includes a conversion circuit that widens a setting range of the luminance data in the display apparatus that drives an optical element.

6. A display apparatus according to claim 1, wherein said drive circuit includes a thin film transistor.

7. A display apparatus according to claim 2, wherein said drive circuit includes a thin film transistor.

8. A display apparatus according to claim 3, wherein said drive circuit includes a thin film transistor.

9. A display apparatus according to claim 4, wherein said drive circuit includes a thin film transistor.

10. A display apparatus according to claim 5, wherein said drive circuit includes a thin film transistor.

11. A display apparatus according to claim 1, wherein said optical element is an organic light emitting diode.

12. A display apparatus according to claim 2, wherein said optical element is an organic light emitting diode.

13. A display apparatus according to claim 3, wherein said optical element is an organic light emitting diode.

14. A display apparatus according to claim 4, wherein said optical element is an organic light emitting diode.

15. A display apparatus according to claim 5, wherein said optical element is an organic light emitting diode.

16. A display apparatus according to claim 6, wherein said optical element is an organic light emitting diode.

17. A display apparatus according to claim 7, wherein said optical element is an organic light emitting diode.

18. A display apparatus according to claim 8, wherein said optical element is an organic light emitting diode.

19. A display apparatus according to claim 9, wherein said optical element is an organic light emitting diode.

20. A display apparatus according to claim 10, wherein said optical element is an organic light emitting diode.
